(19) United States
(12) Patent Application Publication
(10) Pub. No.: US 2016/0377935 A1
(43) Pub. Date: Dec. 29, 2016

(54) LIQUID CRYSTAL DISPLAY DEVICE

(71) Applicant: Samsung Display Co., Ltd., Yongin-si (KR)

(72) Inventors: Hui Gyeong YUN, Yongin-si (KR); Kyung Won PARK, Yongin-si (KR); Kon Haeng LEE, Yongin-si (KR); Kook Hyun CHOI, Yongin-si (KR)

(21) Appl. No.: 15/015,043

(22) Filed: Feb. 3, 2016

(30) Foreign Application Priority Data
Jun. 29, 2015 (KR) 10-2015-0092539

(51) Int. Cl. G02F 1/1343; G02F 1/1339; G02F 1/1368

(52) U.S. Cl. CPC G02F 1/134309; G02F 1/13439; G02F 1/1368; G02F 1/1339; G02F 1/133305

(57) ABSTRACT

An exemplary embodiment of the present disclosure provides a liquid crystal display device, which may comprise: a first substrate including a display area with a pixel area and a non-display area disposed to be adjacent to the display area, a pixel electrode disposed in the display area, a liquid crystal control electrode disposed in the non-display area; a second substrate including a common electrode on a surface facing the first substrate; and a liquid crystal layer disposed between the first substrate and the second substrate.

### CROSS-REFERENCE TO RELATED APPLICATION

This application claims priority from and the benefit of Korean Patent Application No. 10-2015-0092539 filed on Jun. 29, 2015, which is hereby incorporated by reference for all purposes as if fully set forth herein.

### BACKGROUND

Field

Exemplary embodiments relates to a liquid crystal display device.

Discussion of the Background

A liquid crystal display device displays an image by adjusting light transmittance which is changed by liquid crystal molecules rotated by an electric field generated between two electrodes in a liquid crystal display panel. The liquid crystal display panel includes a liquid crystal layer having the liquid crystal molecules, and two substrates between which the liquid crystal layer is interposed.

Meanwhile, a gap between the two substrates (hereinafter, referred to as a “cell gap”) needs to maintain uniformly throughout the liquid crystal display panel. In the liquid crystal display panel, however, when a cell gap of a non-display area is smaller or larger than that of the other area (i.e. a display area), light leakage may occur in the non-display area.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a liquid crystal display device capable of preventing light leakage in a non-display area.

Additional aspects will be set forth in the detailed description which follows, and, in part, will be apparent from the disclosure, or may be learned by practice of the inventive concept.

An exemplary embodiment of the present disclosure provides a liquid crystal display device, which may include: a first substrate including a display area with a plurality of pixel areas and a non-display area disposed to be adjacent to the display area, a pixel electrode disposed in the display area, a liquid crystal control electrode disposed in the non-display area; a second substrate including a common electrode on a surface facing the first substrate; and a liquid crystal layer disposed between the first substrate and the second substrate.

The liquid crystal control electrode may have a shape of surrounding the display area, and may include a plurality of electrode patterns spaced apart from each other on an imaginary line surrounding the display area.

The liquid crystal control electrode may be disposed on the same layer as the pixel electrode and may include a transparent conductive material.

The common electrode may have a shape of extending to the non-display area.

The liquid crystal display device may further include: a thin film transistor which is connected to the pixel electrode in each of pixel areas in the display area, and including a gate electrode, a semiconductor layer, a gate insulating layer insulating the semiconductor layer from the gate electrode, a source electrode, and a drain electrode; and a passivation layer covering the thin film transistor.

The liquid crystal control electrode may be disposed on the passivation layer and may be connected to a liquid crystal control line.

The liquid crystal control line may be disposed on the gate insulating layer.

The liquid crystal display device may further include a sealing pattern which is disposed on the non-display area to attach the first substrate to the second substrate.

The liquid crystal control electrode may be disposed between the display area and the sealing pattern.

Another exemplary embodiment of the present disclosure provides a display device, which may include: a first substrate including a display area and a non-display area disposed to be adjacent to the display area; a second substrate facing the first substrate; a plurality of electrode patterns disposed in the non-display area; and a common electrode disposed in the non-display area corresponding to the plurality of electrode patterns. The plurality of electrode patterns and the common electrode form an electric field therebetween in the non-display area.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is an exploded perspective view of a liquid crystal display device according to an exemplary embodiment of the present disclosure.

FIG. 2 is a plan view for illustrating the liquid crystal display panel shown in FIG.

FIG. 3 is an enlarged view of a region EA1 shown in FIG. 2.

FIG. 4 is a cross-sectional view taken along line I-I′ of FIG. 3.

FIG. 5 is an enlarged view of a region EA2 shown in FIG. 2.

FIG. 6 is a cross-sectional view taken along line II-II′ of FIG. 5.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a”, “an”, and “the” are intended to include the plural forms as well, unless the context clearly indicates otherwise. Moreover, the terms “comprises”, “comprising”, “includes”, and/or “including”, when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

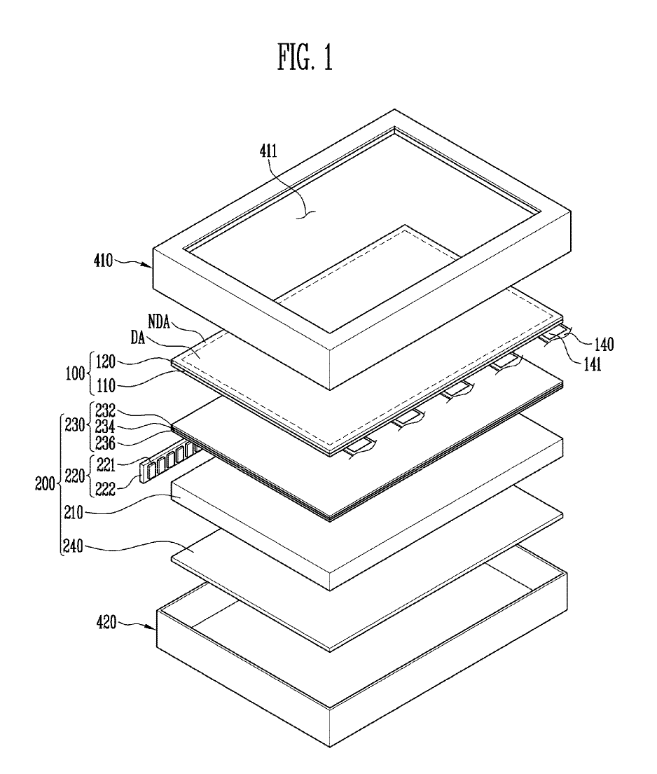

FIG. 1 is an exploded perspective view of a liquid crystal display device according to an exemplary embodiment of the present disclosure.

Referring to FIG. 1, the liquid crystal display device according to the exemplary embodiment of the present disclosure may comprise a liquid crystal display panel 100, a backlight unit 200, an upper cover 410 and a lower cover 420.

The liquid crystal display panel 100 may comprise a display area DA in which an image is displayed, and a non-display area NDA disposed to be adjacent to the display area DA. The liquid crystal display panel 100 may comprise a first substrate 110, a second substrate 120 facing the first substrate 110, and a liquid crystal layer (not shown) interposed therebetween. A pair of polarization films (not shown) may be respectively attached to outer surfaces of the first and second substrates 110 and 120.

A plurality of pixels (not shown) may be disposed in a matrix form in the display area DA of the first substrate 110. Each pixel may comprise a plurality of subpixels, each of which displays a different color from each other. For example, each subpixel may have a color of red, green, blue, cyan, magenta, and yellow. In addition, each pixel may comprise a gate line (not shown), a data line (not shown) crossing and insulated from the gate line, and a pixel electrode (not shown). Each pixel may further comprise a thin film transistor (not shown) electrically connected to the gate line, the data line, and the corresponding pixel electrode. The thin film transistor may turn on or off a driving signal to be supplied to the corresponding pixel electrode.

The second substrate 120 may comprise a color filter (not shown) and a common electrode (not shown). The color filter is disposed on a surface of the second substrate 120 and may represent a predetermined color using light supplied from the backlight unit 200. For example, the color filter may have a color of red, green, blue, cyan, magenta, and yellow. The color filter may be formed through a deposition or coating process. The color filter disposed on the second substrate 120 is described in this exemplary embodiment as an example, but the present disclosure is not necessarily limited thereto. That is, the color filter may be disposed on the first substrate 110. In addition, the common electrode may be formed on the color filter, while facing the pixel electrode (not shown).

The liquid crystal layer may comprise a plurality of liquid crystal molecules. The liquid crystal molecules may be arranged in a particular direction by an electric field generated between the pixel electrode and the common electrode. Accordingly, the liquid crystal layer adjusts transmittance of light supplied from the backlight unit 200, so that the liquid crystal display panel 100 displays an image.

In addition, in the non-display area NDA, a signal input pad (not shown) may be disposed on an outer surface of either one of the first and second substrates 110 and 120. The signal input pad is connected to a flexible substrate 140 on which a driver IC 141 connected to an external circuit module (not shown) are mounted. The driver IC 141 receives various control signals from the external circuit module and outputs a driving signal for driving the liquid crystal panel 100 to the thin film transistor in response to the control signals.

The backlight unit 200 may be disposed in an opposite direction to a direction in which the liquid crystal display panel 100 displays an image. The backlight unit 200 may comprise a light guide plate 210, a light source unit 220 with a plurality of light sources, an optical member 230, and a reflective sheet 240.

The light guide plate 210 may be disposed below the liquid crystal display panel 100. The light guide plate 210 may supply light to the liquid crystal display panel 100 by guiding the light emitting from the light source unit 220. Particularly, the light guide plate 210 necessarily overlaps with the display area DA of the liquid crystal display panel 100. In this case, the light guide plate 210 may have a light-emitting surface emitting the light, a lower surface facing the light-emitting surface, side surfaces linking the light-emitting surface and the lower surface. One or more side surfaces may become light-receiving surfaces to which the light emitting from the light source unit 220 is incident, while facing the light source unit 220. The side surfaces facing the light-receiving surfaces may become light-facing surfaces capable of reflecting the light.

The light source unit 220 may be configured in a manner that a plurality of light sources 221, for example, light-emitting diodes are mounted on a printed circuit board (PCB). In this structure, the light sources 221 may emit the same color. For example, the light sources 221 may emit white light.

In addition, the light sources 221 may emit different colors from each other. For example, some of the light sources 221 may emit red light, others emitting green light and the others emitting blue light.

The light source unit 220 is disposed facing at least one of the side surfaces of the light guide plate 210 to emit light thereto, and thus the liquid crystal display panel 100 may receive the light used for displaying an image through the light guide plate 210.

The optical member 230 may be disposed between the light guide plate 210 and the liquid crystal display panel 100. The optical member 230 may control the light supplied through the light guide plate 210 from the light source unit 220. In addition, the optical member 230 may comprise a diffusion sheet 236, a prism sheet 234, and a protection sheet 232 that are sequentially stacked.

The diffusion sheet 236 may diffuse the light which is incident from the light guide plate 210. The prism sheet 234 may collect the light diffused by the diffusion sheet 236 in a perpendicular direction to a plane of the liquid crystal display panel 100. Most of the light passing through the prism sheet 234 may be incident perpendicularly to the liquid crystal display panel 100. The protection sheet 232 may be disposed on the prism sheet 234 to protect the prism sheet 234 from external impacts.

The optical sheet 230 that includes the diffuser sheet 236, the prism sheet 234, and the protection sheet 232 one by one is described in this embodiment, but the present invention is not necessarily limited thereto. For example, at least one of the diffusion sheet 236, the prism sheet 234, and the protection sheet 232 may be configured by a plurality of sheets that are piled up. In addition, in some cases, any one of the diffusion sheet 236, the prism sheet 234, and the protection sheet 232 may be omitted.

The reflective sheet 240 may be disposed between the light guide plate 210 and the lower cover 420. The reflective sheet 240 reflects the leakage light failing to be incident to the liquid crystal display panel 1001. In other words, the reflective sheet 240 may return a path of the leakage light toward the liquid crystal display panel 100. The reflective sheet 240 may comprise a light reflecting material. Accordingly, the reflective sheet 240 may increase the amount of light to be supplied to the liquid crystal display panel 100.

Meanwhile, the light source unit 220 disposed to supply the light toward the side surface of the light guide plate 210 is described in this exemplary embodiment, but the present disclosure is not necessarily limited thereto. For example, the light source unit 220 may be disposed to supply the light toward the lower surface of the light guide plate 210. In addition, it is possible that the light guide plate 210 is omitted and the light source unit 220 is disposed below the liquid crystal display panel 100 to directly supply the light to the liquid crystal display panel 100.

The upper cover 410 may be disposed above the liquid crystal display panel 100. The upper cover 410 may comprise a display window 411 through which the display area DA of the liquid crystal display panel 100 is exposed. The upper cover 410 may cover edges of a front surface of the liquid crystal display panel 100, i.e., the non-display area NDA.

The lower cover 420 may be disposed below the backlight unit 200. The lower cover 420 may comprise a space for receiving the liquid crystal display panel 100 and the backlight unit 200. In addition, the lower cover 420 is combined with the upper cover 410, while receiving and maintaining the liquid crystal display panel 100 and the backlight unit 200 in an inner space therebetween.

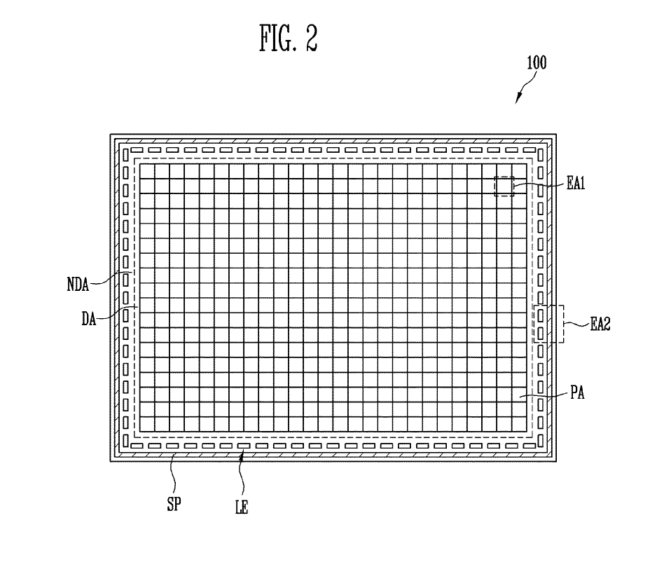

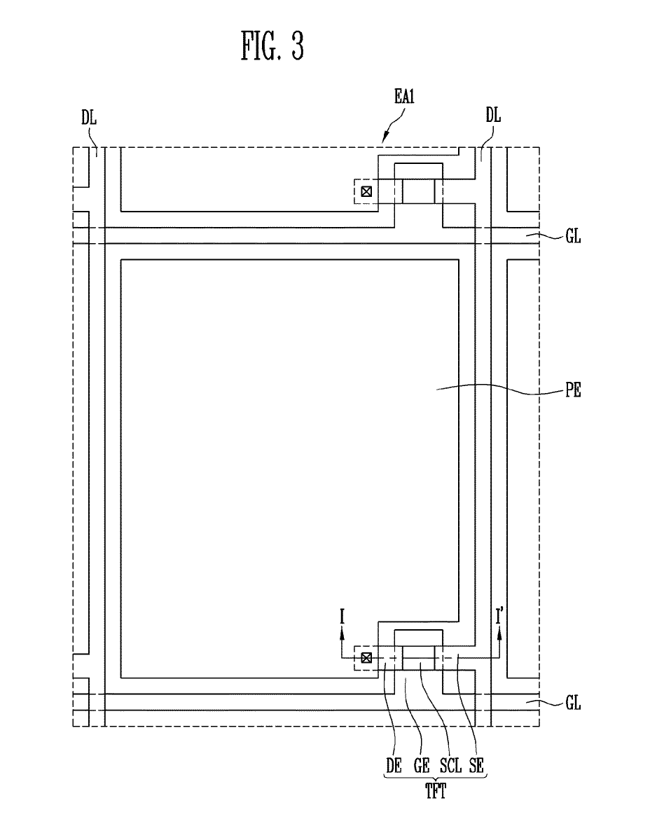

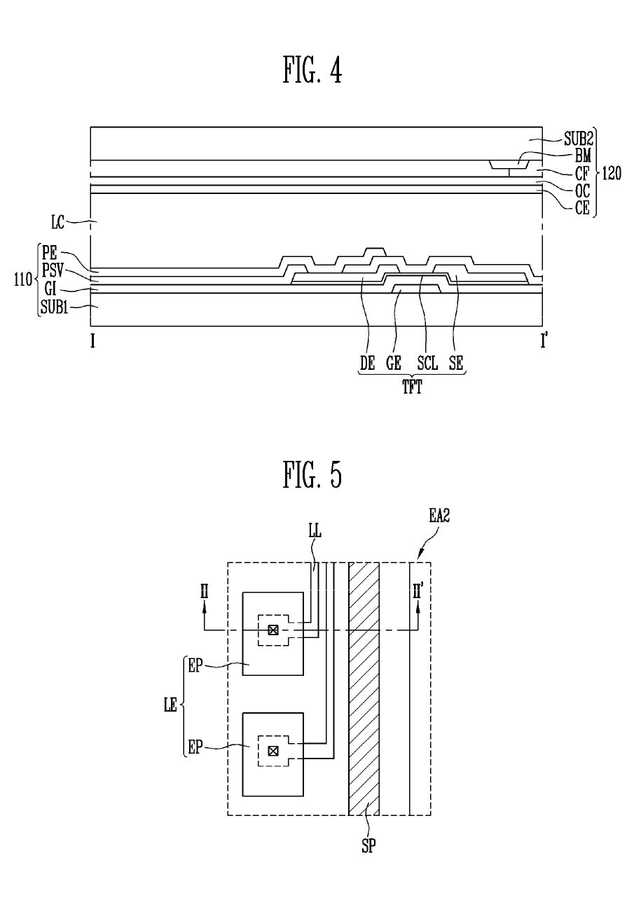

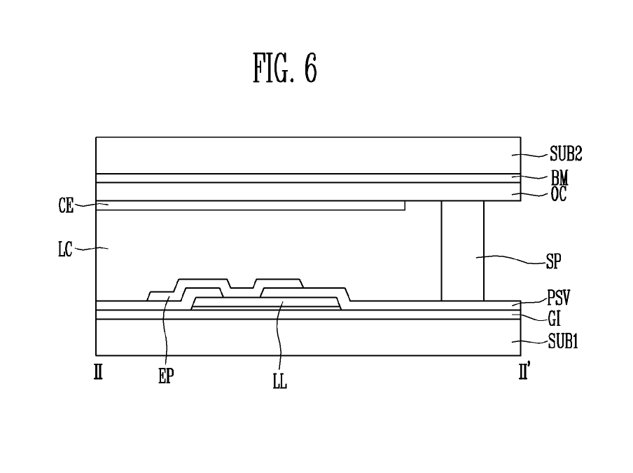

FIG. 2 is a plan view for illustrating the liquid crystal display panel shown in FIG. 1, FIG. 3 is an enlarged view of a region EA1 shown in FIG. 2, FIG. 4 is a cross-sectional view taken along line I-I′ of FIG. 3, FIG. 5 is an enlarged view of a region EA2 shown in FIG. 2, and FIG. 6 is a cross-sectional view taken along line II-II′ of FIG. 5.

Referring to FIG. 1 through FIG. 6, the liquid crystal display panel 100 may comprise the display area DA displaying an image, and the non-display area NDA disposed to be adjacent to the display area DA. The display area DA may comprise a plurality of pixel area PA. The liquid crystal display panel 100 may comprise the first substrate 110, the second substrate 120 facing the first substrate 110, and the liquid crystal layer (not shown) interposed therebetween. The first substrate 110 and the second substrate 120 may be attached to each other by a sealing pattern SP disposed in the non-display area NDA.

The first substrate 110 may comprise a first base substrate SUB1, one or more thin film transistors TFT disposed in each of the pixel areas PA, a pixel electrode PE connected to the thin film transistor, and a liquid crystal control electrode LE disposed in the non-display area NDA.

The first base substrate SUB1 may be formed of a transparent insulating material, thus allowing light to pass therethough. The first base substrate SUB1 may be a rigid substrate. For example, the first base substrate SUB1 may be one of a glass-based substrate, a quartz-based substrate, a glass ceramic-based substrate, and a crystalline glass-based substrate.

In addition, the first base substrate SUB1 may be a flexible substrate. In this case, the first base substrate SUB1 may be one of a film base substrate including a polymer organic material, and a plastic base substrate. For example, the first base substrate SUB1 may comprise one of polyethersulfone (PES), polyarylate (PAR), polyetherimide (PEI), polyethylene naphthalate (PEN), polyethylene terephthalate (PET), polyphenylene sulfide (PPS), polyimide (PI), polycarbonate (PC), triacetate cellulose (YAC), and cellulose acetate propionate (CAP). In addition, the first base substrate SUB1 may comprise fiber glass reinforced plastic.—

Materials applied to the first base substrate SUB1 need to have thermal resistance which is a demanded characteristic in a manufacturing process of the display panel 100.

The thin film transistor TFT may comprise a gate electrode GE, a semiconductor layer SCL, a source electrode SE, and a drain electrode DE.

The thin film transistor TFT will be described below in more detail.

The gate electrode GE may be disposed on the first base substrate SUB1. The gate electrode GE may be connected to the gate line GL. For example, the gate electrode GE may be formed by protruding a partial portion of the gate line GL. In addition, an insulating layer (not shown) may be disposed between the gate electrode GE and the first base substrate SUB1.

A gate insulating layer GI may cover the gate electrode GE. The gate insulating layer GI may comprise at least one of silicon oxide (SiO₂) and silicon nitride (SiNx). For example, the gate insulating layer GI may comprise a silicon oxide layer and a silicon nitride layer formed on the silicon oxide layer.

The semiconductor layer SCL may be disposed on the gate insulating layer GI. A Partial portion of the semiconductor layer SCL may overlap the gate electrode GE. The semiconductor layer SCL may comprise one of amorphous silicon (a-Si), polycrystalline silicon (p-Si), and an oxide semiconductor. Some portions of the semiconductor layer SCL connected to the source electrode SE and the drain electrode DE may become impurity-doped or impurity-injected source and drain regions. A region between the source region and the drain region may become a channel region. In this case, the oxide semiconductor may comprise at least one of Zn, In, Ga, Sn, and a mixture thereof. For example, the oxide semiconductor may comprise indium-gallium-zinc oxide (IGZO).

An end of the source electrode SE may be connected to the data line DL crossing the gate line GL. For example, the source electrode SE may be formed by protruding a partial portion of the data line DL. The other end of the source electrode SE may be connected to an end of the semiconductor layer SCL.

The drain electrode DE and the source electrode SE may be spaced apart from each other. An end of the drain electrode DE may be connected to the other end of the semiconductor layer SCL, and the other end of the drain electrode DE may be connected to the pixel electrode PE.

Meanwhile, in this exemplary embodiment, the thin film transistor TFT of a bottom gate type in which the gate electrode GE is disposed under the semiconductor layer SCL is illustrated as an example, but the structure of the thin film transistor TFT is not necessarily limited to the illustrated example. In other words, a top gate type thin film transistor in which the gate electrode GE is disposed on the semiconductor layer SCL may be used.

The first substrate 110 may further include a passivation layer PSV on the thin film transistor TFT. The passivation layer PSV covers the thin film transistor TFT, while exposing the end of the drain electrode DE connected to the pixel electrode PE.

The passivation layer PSV may comprise at least one of an inorganic passivation layer and an organic passivation layer. For example, the passivation layer PSV may comprise the inorganic passivation layer covering the thin film transistor TFT, and the organic passivation layer disposed on the inorganic passivation layer.

The inorganic passivation layer may comprise at least one of silicon oxide (SiO₂) and silicon nitride (SiNx). For example, the inorganic passivation layer may comprise a first inorganic passivation layer of silicon oxide (SiO₂) that covers the thin film transistor, and a second passivation layer of silicon nitride (SiNx) that is disposed on the first passivation layer.

The organic passivation layer may comprise an organic insulating material allowing light to passing therethrough. For example, the organic passivation layer may comprise at least one of polyacrylates resin, epoxy resin, phenolic resin, polyamides resin, polyimides resin, unsaturated polyesters resin, poly-phenylene ethers resin, poly-phenylene sulfides resin, and benzocyclobutene resin.

The pixel electrode PE may be disposed on the passivation layer PSV. The pixel electrode PE may be connected to the end of the drain electrode DE. The pixel electrode PE may comprise a transparent conductive oxide. For example, the pixel electrode PE may comprise at least one of indium tin oxide (ITO), indium zinc oxide (IZO), aluminum zinc oxide (AZO), gallium doped zinc oxide (GZO), zinc tin oxide (ZTO), gallium tin oxide (GTO), and fluorine doped tin oxide (FTO).

Meanwhile, the pixel electrode PE may comprise a plurality of slits (not shown) for minutely controlling the liquid crystal molecules included in the liquid crystal layer LC.

A liquid crystal control electrode LE may be disposed on the passivation layer PSV in the non-display area NDA. More specifically, the liquid crystal control electrode LE may comprise a plurality of electrode patterns EP. Referring to FIGS. 5 and 6, the plurality of electrode patterns EP may be disposed on the passivation layer PSV and disposed on the same layer as the pixel electrode PE. In addition, the liquid crystal control electrode LE, that is the plurality of electrode patterns EP may comprise the same material as the pixel electrode PE.

The liquid crystal control electrode LE may be disposed between the display area DA and the sealing pattern SP as described in FIG. 1. Referring to FIG. 1, the liquid crystal control electrode LE may have a shape of surrounding the display area DA. In addition, the liquid crystal control electrode LE may comprise a plurality of electrode patterns EP spaced apart from each other on an imaginary line surrounding the display area DA.

Referring to FIGS. 5 and 6, the electrode patterns EP may be respectively connected to a plurality of liquid crystal control signal lines LL. The liquid crystal control signal lines LL, the source electrode SE, the drain electrode DE, and the data line DL may be disposed in the same layer. That is, the liquid crystal control signal lines LL may be disposed on the gate insulating layer GI. In addition, the liquid crystal control signal lines LL, the source electrode SE, the drain electrode DE, and the data line DL may comprise the same material.

Referring to FIG. 4, the second substrate 120 may be a substrate facing the first substrate 110. The second substrate 120 may comprise a second base substrate SUB2, a light-blocking pattern BM, a color filter CF, an overcoat layer OC, and a common electrode CE.

The second base substrate SUB2 may comprise the same material as the first base substrate SUB1. That is, the base second substrate SUB2 may be a rigid or flexible substrate.

The light-blocking pattern BM may be disposed on a surface of the second base substrate SUB2 facing the first the base substrate SUB1. The light-blocking pattern BM may be formed to correspond to borders of the pixel areas PA. In addition, the light-blocking pattern BM may prevent light leakage caused by misalignment of the liquid crystal.

The color filter CF may have one color of red, green, blue, cyan, magenta, and yellow. The color filter CF may be formed to correspond to the pixel areas PA. Meanwhile, the color filter CF of this exemplary embodiment is disposed on the second substrate 120, but the present disclosure is not necessarily limited thereto. For example, the color filter CF may be disposed on the first substrate 110.

The overcoat layer OC may cover the color filter CF. In addition, the overcoat layer OC may decrease a step between the light-blocking layer BM and the color filter CF. That is, the overcoat layer OC may planarize the surface of the second substrate 120.

The common electrode CE may be disposed on a surface of the second substrate 120 facing the first substrate 110. For example, the common electrode CE may be disposed on the overcoat layer OC. The common electrode CE may comprise the same material as the pixel electrode PE. The common electrode CE may comprise a transparent conductive material. In addition, the common electrode CE may extend to the non-display area NDA.

The liquid crystal layer LC may be disposed between the first substrate 110 and the second substrate 120. Liquid crystal molecules of the liquid crystal layer LC adjust transmittance of the light by aligning in a particular direction by an electric field formed between the pixel electrode PE and the common electrode CE. Accordingly, the liquid crystal layer LC may transmit the light supplied from the backlight unit 200 for the liquid crystal panel 100 to display an image.

Meanwhile, bending of the first and second base substrates SUB1 and SUB2 may bring a problem that a cell gap of the liquid crystal display panel 100 in the display area DA and a cell gap of the liquid crystal display panel 100 in the non-display area NDA are different. A difference of the cell gap between the display area DA and the non-display area NDA may also bring a problem of light leakage in the non-display area NDA. This is because the liquid crystal molecules do not align in a light-blocking direction and align in a direction in which some light is allowed to pass. The problem of the light leakage occurring in the non-display area NDA may be solved by the electrode patterns EP of the liquid crystal control electrode LE.

More specifically, when the light leakage occurs (or is detected) in the non-display area NDA, a liquid crystal control signal may be applied to the electrode patterns EP through the liquid crystal control line LL. In response to the liquid crystal control signal, the electrode patterns EP and the common electrode CE form an electric field therebetween. The electric field formed between the electrode patterns EP and the common electrode CE may control the liquid crystal molecules. In particular, in the non-display area NDA, the electric field formed between the electrode patterns EP and the common electrode CE may align the liquid crystal molecules in a direction not allowing the light supplied from the backing unit 200 to pass through. As a result, the liquid crystal display panel 100 may prevent the light leakage in the non-display area NDA.

In addition, since the liquid crystal display panel 100 prevents the light leakage in the non-display area NDA by controlling the liquid crystal molecules, a width of the non-display area NDA can be reduced. Accordingly, a width of an area of the upper cover 410 overlapping the non-display area NDA can be reduced.

Exemplary embodiments have been disclosed herein and although specific terms are employed, they are used and are to be interpreted in a generic and descriptive sense only and not for purpose of limitation. In some instances, as would be apparent to one of ordinary skill in the art as of the filing of the present application, features, characteristics and/or elements described in connection with a particular embodiment may be used singly or in combination with features, characteristics and/or elements described in connection with other embodiments unless otherwise specifically indicated. Accordingly, it will be understood by those of skill in the art that various changes in forms and details may be made without departing from the spirit and scope of the present invention as set forth in the following claims.

What is claimed is:

1. A liquid crystal display device, comprising:
a first substrate including a display area with a plurality of pixel areas and a non-display area disposed to be adjacent to the display area;
a pixel electrode disposed in the display area;
a liquid crystal control electrode disposed in the non-display area;
a second substrate including a common electrode on a surface facing the first substrate; and
a liquid crystal layer disposed between the first substrate and the second substrate.

2. The liquid crystal display device of claim 1, wherein the liquid crystal control electrode has a shape of surrounding the display area.

3. The liquid crystal display device of claim 2, wherein the liquid crystal control electrode includes a plurality of electrode patterns spaced apart from each other on an imaginary line surrounding the display area.

4. The liquid crystal display device of claim 3, wherein the liquid crystal control electrode is disposed on the same layer as the pixel electrode.

5. The liquid crystal display device of claim 4, wherein the liquid crystal control electrode includes a transparent conductive material.

6. The liquid crystal display device of claim 1, wherein the common electrode has a shape of extending to the non-display area.

7. The liquid crystal display device of claim 1, further comprising:
a thin film transistor connected to the pixel electrode in each of pixel areas in the display area, and including a gate electrode, a semiconductor layer, a gate insulating layer insulating the semiconductor layer from the gate electrode, a source electrode, and a drain electrode; and
a passivation layer covering the thin film transistor.

8. The liquid crystal display device of claim 7, wherein the liquid crystal control electrode is disposed on the passivation layer.

9. The liquid crystal display device of claim 8, wherein the liquid crystal control electrode is connected to a liquid crystal control line.

10. The liquid crystal display device of claim 9, wherein the liquid crystal control line is disposed on the same layer as the source electrode and the drain electrode.

11. The liquid crystal display device of claim 10, wherein the liquid crystal control line is disposed on the gate insulating layer.

12. The liquid crystal display device of claim 1, further comprising a sealing pattern disposed in the non-display area to attach the first substrate to the second substrate.

13. The liquid crystal display device of claim 12, wherein the liquid crystal control electrode is disposed between the display area and the sealing pattern.

14. A display device, comprising:
a first substrate including a display area and a non-display area disposed to be adjacent to the display area;
a second substrate facing the first substrate;
a plurality of electrode patterns disposed in the non-display area; and
a common electrode disposed in the non-display area corresponding to the plurality of electrode patterns,
wherein the plurality of electrode patterns and the common electrode form an electric field therebetween in the non-display area.

15. The display device of claim 14, wherein the common electrode has a shape of extending from the display area to the non-display area.

16. The display device of claim 14, wherein the plurality of electrode patterns are spaced apart from each other on an imaginary line surrounding the display area.

17. The display device of claim 14, further comprising a sealing pattern disposed in the non-display area to attach the first substrate to the second substrate.

18. The display device of claim 14, wherein the plurality of electrode patterns are disposed between the display area and the sealing pattern.

19. The display device of claim 14, wherein each of the plurality of electrode patterns is connected to a liquid crystal control line corresponding thereto.

20. The display device of claim 14, wherein at least one of the first substrate and the second substrate is flexible.
